(19) United States
(12) Patent Application Publication
(10) Pub. No.: US 2026/0161050 A1
(43) Pub. Date: Jun. 11, 2026

(54) LENS BARREL, OBSERVATION APPARATUS, AND IMAGE PICKUP APPARATUS

(71) Applicant: CANON KABUSHIKI KAISHA, Tokyo (JP)

(72) Inventor: KOICHI ITO, Tokyo (JP)

(21) Appl. No.: 19/181,720

(22) Filed: Apr. 17, 2025

(30) Foreign Application Priority Data
Jun. 6, 2024 (JP) 2024-091966

(51) Int. Cl. G03B 13/06; G02B 7/02

(52) U.S. Cl. CPC G03B 13/06; G02B 7/021

(57) ABSTRACT

A lens barrel includes a first fixed member and a second fixed member fixed to each other, a lens disposed inside the first fixed member, and an elastic member disposed between the first fixed member and the second fixed member in an optical axis direction. The elastic member has a first area that is disposed between the second fixed member and the lens and biases the lens, and a second area whose entire circumference is sandwiched between the first fixed member and the second fixed member. A surface of the first area that biases the lens is different from a surface of the second area that biases the first fixed member.

### BACKGROUND

### Technical Field

The present disclosure relates to a lens barrel, an observation apparatus, and an image pickup apparatus.

### Description of Related Art

Some conventional cameras employs a structure in which a single elastic member seals a plurality of locations. Japanese Patent Application Laid-Open No. 2016-206270 discloses a structure that uses a sealing member having a plurality of protrusions to secure waterproofing and dustproofing.

Electronic viewfinder (EVF) units that have optical plastic lenses have recently been demanded to use a single elastic member to hold the lens and seal for anti-fogging (to prevent condensation inside the lens). The structure disclosed in Japanese Patent Application Laid-Open No. 2016-206270 presumes the use of a screw-in type lens holding frame, and attempts to ensure sealing. Therefore, the structure disclosed in Japanese Patent Application Laid-Open No. 2016-206270 applied to the EVF unit has difficulty in holding the lens and sealing for anti-fogging while suppressing the deformation of the optical plastic lens.

### SUMMARY

A lens barrel according to one aspect of the disclosure includes a first fixed member and a second fixed member fixed to each other, a lens disposed inside the first fixed member, and an elastic member disposed between the first fixed member and the second fixed member in an optical axis direction. The elastic member has a first area that is disposed between the second fixed member and the lens and biases the lens, and a second area whose entire circumference is sandwiched between the first fixed member and the second fixed member. A surface of the first area that biases the lens is different from a surface of the second area that biases the first fixed member. An observation apparatus and an image pickup apparatus each having the above lens barrel also constitute another aspect of the disclosure.

Further features of various embodiments of the disclosure will become apparent from the following description of embodiments with reference to the attached drawings.

### BRIEF DESCRIPTION OF THE DRAWINGS

FIG. 1 is a schematic diagram of a camera body including a lens barrel according to a first embodiment.

FIGS. 2A, 2B, and 2C explain a lens barrel according to the first embodiment.

FIG. 3 is a sectional view taken along line A-A in FIG. 2A.

FIGS. 4A and 4B explain a lens holder according to the first embodiment.

FIG. 5 explains a lens barrel according to a second embodiment.

### DETAILED DESCRIPTION

Referring now to the accompanying drawings, a detailed description will be given of embodiments according to the disclosure. Corresponding elements in respective figures will be designated by the same reference numerals, and a duplicate description thereof will be omitted.

### FIRST EMBODIMENT

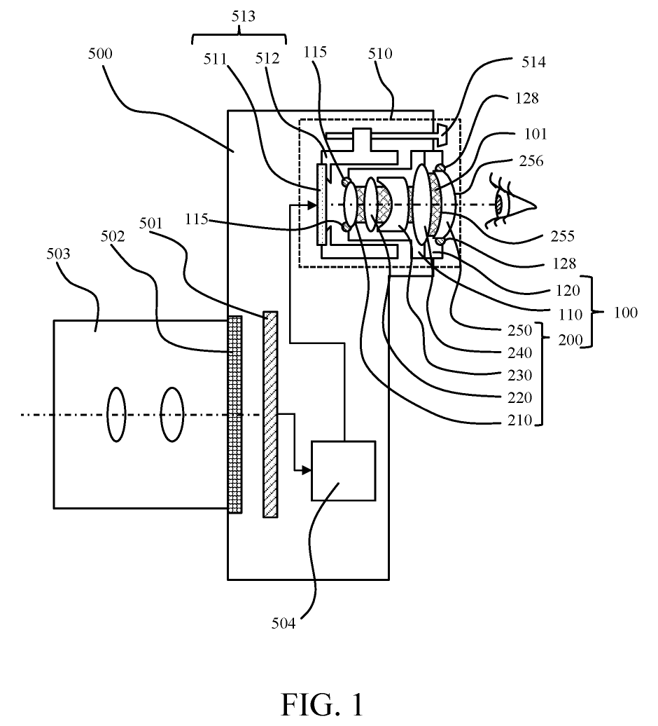

FIG. 1 is a schematic diagram of a camera body (image pickup apparatus) 500 mounted with a lens barrel 100 according to the present embodiment. The camera body 500 is a lens interchangeable type single-lens reflex camera, a so-called mirrorless camera. An imaging lens 503 for forming an object image is connected to the camera body 500 via a camera mount 502. Light rays incident from the imaging lens 503 are guided to an image sensor 501, such as a CMOS sensor disposed inside the camera body 500. The object image is photoelectrically converted by the image sensor 501 and input to a CPU 504. The information input into the CPU 504 is processed by a proper program, output to an EVF unit (observation apparatus) 510, and presented to the user as a displayed image.

The EVF unit 510 includes a panel unit 513, a lens barrel 100 that includes a lens holder (first fixed member) 110, a lens cover (second fixed member) 120, and an optical lens 200, and a diopter adjusting unit 514.

The panel unit 513 includes an EVF panel 511 and an EVF panel holder 512 that holds the EVF panel 511, and is attached to the objective lens (G1 lens) side. The EVF panel 511 includes, for example, an organic EL panel or a backlit LCD panel that converts image information from the CPU 504 into a displayed image.

The diopter adjusting unit 514 changes a distance between the EVF panel holder 512 and the lens barrel 100 by user operation to adjust the diopter to the eyesight, or to perform so-called diopter adjustment. A detailed description of a movable mechanism is omitted, but it generally includes a mechanism that changes a relative position by an operation unit such as a dial or slider, and a cam. In this embodiment, the diopter adjusting unit 514 moves the panel unit 513 relative to the lens barrel 100 fixed to the camera body 500. For anti-fogging of the lens barrel 100, a sealed structure may be provided on the eyepiece (G5 lens) side, which is most likely to fog up. Therefore, this embodiment can easily design a diopter adjusting structure that fixes the lens barrel 100 having a sealed structure and moves the panel unit 513. However, the structure of the diopter adjusting unit 514 is not limited to this example, and the lens barrel 100 may be moved relative to the fixed panel unit 513.

The lens barrel 100 holds the optical lens 200 that forms a displayed image of the EVF panel 511 as an image visible to the user. In this embodiment, a G1 lens 210, a G2 lens 220, a G3 lens 230, a G4 lens 240, and a G5 lens 250 arranged in this order from the EVF panel 511 side to the user side are collectively referred to as the optical lens 200. The G1 lens 210 is an objective lens, and the G5 lens 250 is an eyepiece lens.

The EVF unit 510 is intended for use in low-temperature to high-temperature environments, and has high anti-fogging performance. For example, in a case where the camera body 500 is in a warm environment and a lens surface 256 of the G5 lens 250 on the user side comes into contact with cold outside air due to a sudden change in environment, the entire G5 lens 250 is cooled. As a result, the internal air 101 of the warm lens barrel 100 locally falls below the dew point near a lens surface 255 on the EVF panel 511 side of the cooled G5 lens 250, and the contained water vapor condenses.

As an anti-condensation countermeasure in the EVF unit 510, it is useful to seal the inside of the lens barrel 100 to confine the internal air 101 and suppress the intrusion of water vapor from the outside of the lens barrel 100. Therefore, this embodiment seals the lens holder 110 with a G1 lens sealing 115, and seals the lens cover 120 with a G5lens sealing 128. The space between the lens holder 110 and the lens cover 120 is sealed with a barrel gasket (elastic member) 130.

The method of suppressing condensation on the lens surface 255 of the G5 lens 250 is not limited to confining the internal air 101. For example, a method may be used that suppresses a temperature decrease of the lens surface 255 due to a decrease in the outside air temperature by increasing the heat capacity of the G5 lens 250. Another method is to place a moisture absorbent in an area of the internal air 101. Another method is to prevent a temperature difference between the inside and outside of the camera body 500 by making the internal air 101 completely replaceable with the outside air, but this method is not suitable in a case where dustproof and drip-proof performance is required for the camera body 500. Therefore, for the intended use of the camera body 500, isolating internal air 101 from external air and configuring the lens barrel 100 in a sealed structure is suitable to suppress condensation and improve anti-fogging performance.

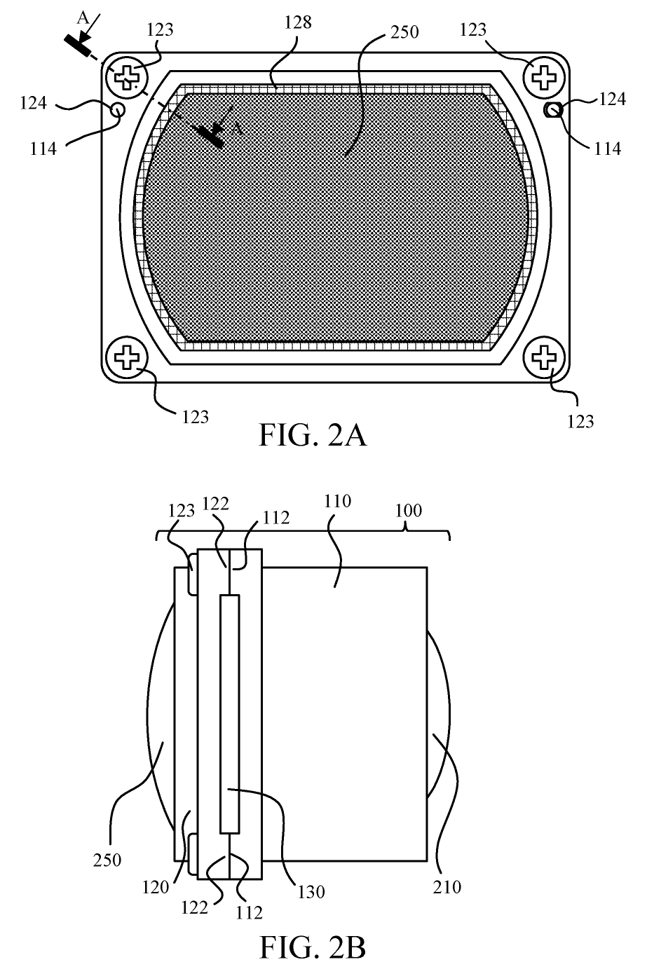

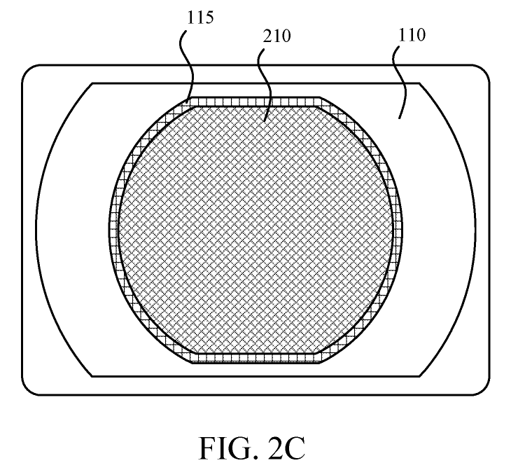

FIGS. 2A, 2B, and 2C, explain the lens barrel 100. FIG. 2A is a front view of the lens barrel 100 (the lens barrel 100 viewed from the eyepiece side). FIG. 2B is a side view of the lens barrel 100. FIG. 2C is a rear view of the lens barrel 100 (the lens barrel 100 viewed from the objective lens side).

The lens barrel 100 is configured such that the lens holder 110 and the lens cover 120 are fixed by cover fixing screws 123 in a manner that sandwiches the barrel gasket 130.

The lens holder 110 is an inelastic lens holding member that holds a part or all of the lenses in the optical lens 200 other than at least G5 lens 250, which is the eyepiece lens. The lens holder 110 holds the lens mask. In this embodiment, the lens holder 110 is made of engineering plastic, but the material may be metal. The lens holder 110 may have metal deposition on the inside or outside to suppress moisture permeability. The inside may be painted or matte-finished to prevent reflection.

An opening is provided on the G1 lens 210 side of the lens holder 110. The G1 lens 210 is fixed in the opening of the lens holder 110 by the G1 lens sealing 115.

In this embodiment, the G1 lens 210 is made of circular optical glass with the top and bottom cut, but the shape and material are not limited to this example. The shape is not limited to circular and may be square. It may be an irregular shape with a part cut off. Optical plastic, ceramic, sapphire crystal, etc. may be used. The G1 lens sealing 115 is made of, for example, a UV resin adhesive that hardens with UV light, and fixes the entire outer periphery of the G1 lens 210. The G1 lens sealing 115 is used to seal the gap between the G1 lens 210 and the lens holder 110. The G1 lens 210 and the lens holder 110 may be fixed by another method. For example, a part of the lens holder 110 may be thermally melted to fix the G1 lens 210 by crimping, and then a sealing putty may be applied to the entire circumference of the gap.

The lens cover 120 holds one or more lenses including at least the G5 lens 250 in the optical lens 200. In this embodiment, the lens cover 120 is made of engineering plastic like the lens holder 110, but it may be made of another material. An opening is provided on the G5 lens 250 side of the lens cover 120. In the opening of the lens cover 120, the G5 lens 250 is fixed by the G5 lens sealing 128. The G5 lens sealing 128 is made, for example, of a UV resin adhesive that hardens by UV light, and fixes the outer circumference of the G5 lens 250. The G5 lens sealing 128 is used to seal the gap between the G5 lens 250 and the lens cover 120. The gap between the G5 lens 250 and the lens cover 120 may be fixed by another method.

The lens holder 110 and the lens cover 120 are positioned relative to each other by lens cover positioning dowels 114 and the positioning holes 124, and are fastened and fixed by the cover fixing screws 123. A lens holder fastening surface 112 of the lens holder 110 contacts a lens cover fastening surface 122 of the lens cover 120. The barrel gasket 130 is sandwiched between the lens holder 110 and the lens cover 120, and is biased by the fastening and fixing.

In this embodiment, for easy disassembly and reassembly in the event of maintenance or a malfunction, the lens holder 110 and the lens cover 120 are fastened and fixed by the cover fixing screws 123. However, the fastening method is not limited to screwing, and another method may be used as long as the barrel gasket 130 can be fixed while being biased. For example, it may be fixed by adhesion or welding.

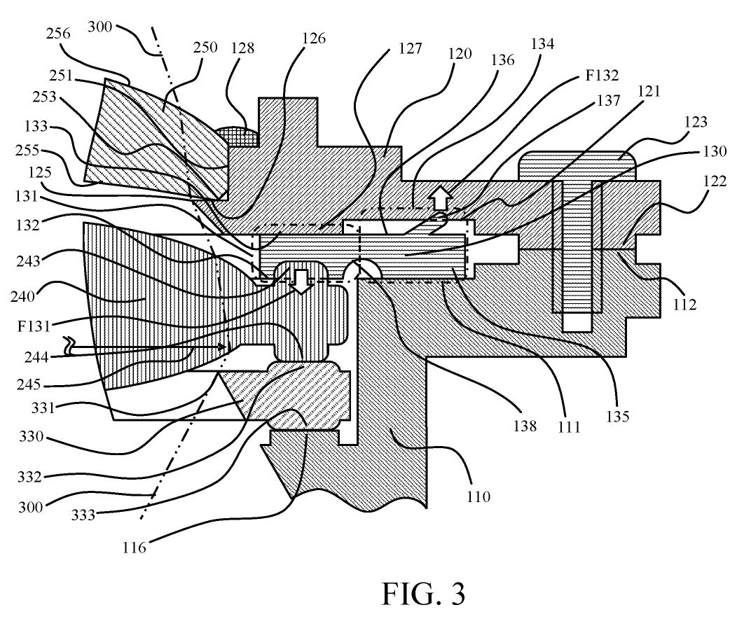

FIG. 3 is a sectional view of line A-A in FIG. 2A. The optical axis direction is in the upward direction on the paper.

A G3G4 mask 330 and the G4 lens 240 are fixed inside the lens holder 110. The G2 lens 220 and the G3 lens 230 are fixed inside the lens holder 110. The effective light beam inside the lens barrel 100 is indicated by a light beam area 300. The light beam from the EVF panel 511 passes through the left area of the light beam area 300 on the paper.

A G5 lens opening 125 is opened in the lens cover 120. The G5 lens 250 is attached to cover the G5 lens opening 125. The G5 lens outer circumference 251 of the G5 lens 250 is in an engagement relationship with the G5 lens opening 125, and the position of the G5 lens 250 in the optical axis normal direction relative to the lens cover 120 is determined. The position of the G5 lens 250 in the optical axis direction is determined by the contact of a cover contact surface 253 with a G5 lens contact surface 126 of the lens cover 120, and the lens is sealed and fixed by the G5 lens sealing 128.

The G3G4 mask 330 is an inelastic light-shielding member for shielding unnecessary light beams passing inside and outside the optical lens 200. The G3G4 mask 330 is made of metal or engineering plastic. It may be matte-finished or painted, if necessary. The G3G4 mask 330 is provided with a G3G4 mask opening 331. The G3G4 mask opening 331 defines an effective light beam. The G3G4 mask opening 331 includes a G3G4 mask contact portion 333 that contacts an optical component contact surface 116 of the lens holder 110, and a G3G4 mask contact portion 332 that contacts the G4 lens 240. In this embodiment, the G3G4 mask 330 is an inelastic member different from the lens holder 110, but it may be the same inelastic member.

The G3G4 mask contact portion 332 contacts a G4 lens contact portion 244 that is positioned outside the effective lens surface range of the G4 lens 240. The G4 lens 240 is made of an optical plastic lens, and has the largest effective light beam area 245 of the light beam area 300 in the optical lens 200.

The barrel gasket 130 is made of butyl rubber or fluororubber. The barrel gasket 130 is manufactured by impression molding, which is a common method for rubber molding, but may be made by cutting or three-dimensional printer lamination as long as the intended shape can be obtained. The function of the barrel gasket 130 is to seal for anti-fogging, so the material is to have low gas permeability, especially low water vapor permeability. Depending on the product purpose and usage environment, so-called silicone rubber or another part may be acceptable, but silicone rubber has high gas permeability including water vapor. Therefore, butyl rubber or fluororubber, which has low water vapor permeability, is suitable.

In a case where the lens cover 120 is not attached, the optical component contact surface 116 contacts the G3G4 mask contact portion 333. The G3G4 mask contact portion 332 contacts the G4 lens contact portion 244. At this time, the G3G4 mask 330 and the G4 lens 240 are simply placed on the lens holder 110, and in this state, their positions are not fixed and the desired optical performance is not obtained. Therefore, the G3G4 mask 330 and the G4 lens 240 are fixed to the lens holder 110. However, the G4 lens 240 is made of optical plastic and is sensitive to load, and fixing with adhesive or thermal caulking may cause twisting or distortion, resulting in a decrease in surface accuracy. In addition, depending on the material of the G4 lens 240, adhesive with proper adhesive strength may not exist.

Accordingly, in this embodiment, in attaching the lens cover 120, the barrel gasket 130 is placed so that an inner area (first area) 131 is compressed between the inner gasket contact surface 127 of the lens cover 120 and the G4 lens pressing portion 243 of the G4 lens 240. Thereby, the G4 lens 240 and the G3G4 mask 330 can be fixed by biasing. In other words, the G4 lens 240 is sandwiched between the barrel gasket 130 and the G3G4 mask 330. At this time, the G4 lens 240 and the G3G4 mask 330 are biased and fixed toward the lens holder 110 by an inward biasing force (first biasing force) F131 generated when the lens biasing surface 132 of the barrel gasket 130 is compressed by the G4 lens pressing portion 243. At this time, the positions of the G4 lens pressing portion 243, the G4 lens contact portion 244, the G3G4 mask contact portion 332, and the G3G4 mask contact portion 333 may not be shifted relative to a plane perpendicular to the optical axis. In a case where the positions are shifted relative to the plane perpendicular to the optical axis, a torsional force is applied to the G4 lens 240 and the G3G4 mask 330, and optical performance may deteriorate. Therefore, the G4 lens pressing portion 243 and the G4 lens contact portion 244 are provided so as to overlap each other when viewed from the optical axis direction. The G3G4 mask contact portion 332 and the G3G4 mask contact portion 333 are provided so that they overlap each other when viewed from the optical axis direction. In order to stably secure flatness regardless of the torsional strength of the G4lens 240, at least three points for each of the G4 lens pressing portion 243, the G4 lens contact portion 244, the G3G4 mask contact portion 332, and the G3G4 mask contact portion 333 may be provided.

Each of the inner gasket contact surface 127 and the lens cover contact surface 133 is approximately flat. Thereby, the inner biasing force F131 can be stabilized regardless of variations in the components of the lens cover 120 and the G4 lens 240 and their relative positions. The flat area of the lens cover contact surface 133 may be wider than the area of the G4 lens pressing portion 243.

In an outer area (second area) 134 of the barrel gasket 130, a lens holder contact surface (contact surface) 135 contacts a gasket contact surface 111 of the lens holder 110. An outer biasing protrusion 137 protruding from the lens cover contact surface 136 comes into contact with an outer-circumference-side gasket contact surface 121 of the lens cover 120 and is compressed, generating an outer biasing force (first biasing force) F132, and sealing the space between the lens holder 110 and the lens cover 120.

In assembly, the barrel gasket 130 is placed over the G4 lens 240 and the lens holder 110 on which the G4 lens 240 is placed, and then the lens cover 120 is placed over it. At this time, when the lens cover 120 is placed over it, it becomes difficult to visually recognize the barrel gasket 130, and if the contact of the barrel gasket 130 is unstable, the barrel gasket 130 becomes twisted when the lens cover 120 is attached, and post-assembly sealing may be insufficient. Thus, the gasket contact surface 111 and the lens holder contact surface 135 are approximately flat. Thereby, the barrel gasket 130 can be stably placed on the gasket contact surface 111. Since the outer area 134 is provided to seal the inside of the lens barrel 100, the lens holder contact surface 135 and the biasing protrusion 137 are arranged in a ring shape with approximately the same shape on the entire circumference. A relationship between the outer-circumference-side gasket contact surface 121 and the biasing protrusion 137 is also constant over the entire circumference so that the sealing is not incomplete due to biasing of the biasing force.

In this embodiment, the biasing protrusion 137 has a fin-like shape that tilts outward from the optical axis. This structure can suppress an excessively strong biasing force, stabilizes the screwing forces in tightening the cover fixing screws 123, and improves workability.

The barrel gasket 130 has the inner area 131 that is sandwiched between the lens cover 120 and the G4 lens 240 and biases the G4 lens 240 and the G3G4 mask 330. The barrel gasket 130 has the outer area 134 that is sandwiched around the entire circumference between the lens holder 110 and the lens cover 120 to bias the lens cover 120 and seal the inside of the lens barrel 100. At this time, the inner area 131 that biases the G4 lens 240 and the G3G4 mask 330 and the outer area 134 that seals the inside of the lens barrel 100 have different functions. However, manufacturing them as an integrated part is suitable for simple structure and assembly performance. Therefore, this embodiment forms the barrel gasket 130 as an integrated part in which the inner area 131 and the outer area 134 are connected.

As illustrated in FIG. 3, this embodiment sets the heights of the inner area 131 and the outer area 134 to be approximately the same. Thereby, the volume of the integrated barrel gasket 130 can be formed as small as possible. However, in a case where the lens biasing surface 132 and the lens holder contact surface 135 are formed on the same surface that is easily affected by mutual displacement, due to the relative heights of the gasket contact surface 111 and the G4 lens pressing portion 243, a biasing force may be insufficient or excessive in one of the inner and outer areas. Hence, this embodiment provides a notch 138 between the lens biasing surface 132 and the lens holder contact surface 135 to divide the lens biasing surface 132 and the lens holder contact surface 135 into noncoplanar surfaces. Providing the notch 138 is merely illustrative, the structure is not limited as long as the lens biasing surface 132 and the lens holder contact surface 135 are less susceptible to mutual displacement. Thus, the notch 138 is not necessary and, for example, the lens biasing surface 132 and the lens holder contact surface 135 may form a step.

The inner biasing force F131 generated in the inner area 131 is a force for biasing the G4 lens 240 made of optical plastic, which is prone to distortion, and the outer biasing force F132 generated in the outer area 134 is a force for reliably sealing the gap between the lens holder 110 and the lens cover 120. Thus, the inner biasing force F131 and the outer biasing force F132 are set to be different from each other. More specifically, the inner biasing force F131 for biasing the G4 lens 240 and the G3G4 mask 330 is set to be weaker (smaller) than the outer biasing force F132 for sealing.

The lens barrel 100 is to be divided into the lens holder 110 and the lens cover 120 in order to provide the lens barrel 100 with the sealing property for the following reasons.

If an effective light beam area of the eyepiece lens (G5 lens 250) or the objective lens (G1 lens 210) is the widest area in the light beam area 300 of the optical lens 200, the division and sealing design of the lens holder 110 and lens cover 120 are relatively easy. For example, the lens holder 110 can have a box shape, and the lenses can be assembled in order so that the lens with the widest effective light beam area is placed last, and then covered with the lens cover 120 together with a gasket that has a sealing function for the lens. Alternatively, the lens cover 120 may be eliminated and the outermost lens may be fixed with a gasket or adhesive.

However, in a case where the effective light beam area of the lens that is not the outermost end of the optical lens 200 is the widest area, the above method is not suitable. It is necessary to hold the lens in each of the lens holder 110 and the lens cover 120, and to seal the gap between the lens holder 110 and the lens cover 120 (the gap between the G4 lens 240 and the G5 lens 250, which has the largest effective light beam area 245 in this embodiment). In particular, for assembly performance, it is important to place a gap between the G4lens 240 and an adjacent lens that is assembled after the G4 lens 240 in the component assembly order in the optical axis direction of the optical lens 200. Thereby, the inner area 131 and the outer area 134 of the barrel gasket 130 can be integrated and formed as simply as possible.

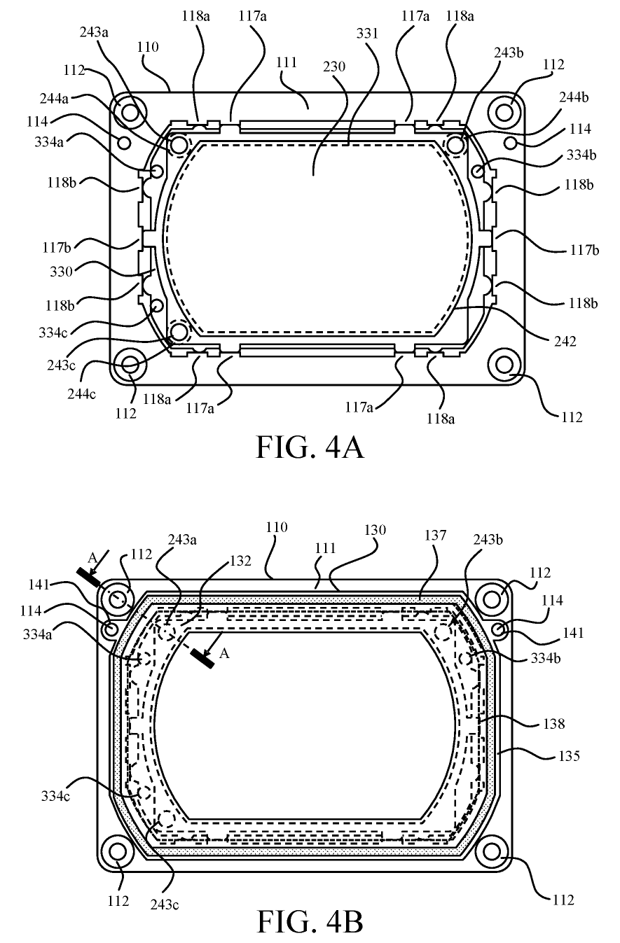

The structure of the barrel gasket 130 will be described below with reference to FIGS. 4A and 4B. FIGS. 4A and 4B explain the lens holder 110. FIG. 4A illustrates a state in which the lens cover 120, the cover fixing screw 123, and the barrel gasket 130 have been removed from the state illustrated in FIG. 2A.

The G3G4 mask 330 is positioned in the lens holder 110 by G3G4 mask positioning portions. Four G3G4 mask positioning portions 118a (two pairs) are provided in the vertical direction of the paper, and four G3G4 mask positioning portions 118b (two pairs) are provided in the horizontal direction of the paper.

The G4 lens 240 is positioned in the lens holder 110 by G4 lens positioning portions. Four G4lens positioning portions 117a (two pairs) are provided in the vertical direction of the paper, and two G4 lens positioning portions 117b (one pair) are provided in the horizontal direction of the paper.

Here, G4 lens pressing portions 243a, 243b, and 243c are disposed on the outside of the lens surface 242 on the user side of the G4 lens 240. G4 lens contact portions 244a, 244b, and 244c are disposed at approximately the same positions in the optical axis direction of those of the G4 lens pressing portions 243a, 243b, and 243c. The G4 lens contact portions 244a, 244b, and 244c contact the G3G4 mask contact portion 332. The G3G4 mask 330 includes G3G4 mask pressing portions 334a, 334b, and 334c.

FIG. 4B illustrates a state in which barrel gasket 130 is attached to FIG. 4A. A line A-A in FIG. 4B is the same as the line A-A in FIG. 2.

As illustrated in FIG. 4B, the barrel gasket 130 is disposed on the gasket contact surface 111. Two gasket position fixing holes 141 are formed in the barrel gasket 130 as a rotation prevention mechanism. The gasket position fixing holes 141 into which two lens cover positioning dowels 114 are inserted suppress the positional shift of the barrel gasket 130 and attachment failure.

In this embodiment, the barrel gasket 130 is noncircular, unlike a general gasket that is screwed and fixed by the circular lens cover 120, so that it can simultaneously bias a plurality of optical components in the optical axis direction. In the inner area 131 of the barrel gasket 130, the lens biasing surface 132 is compressed by the G4 lens pressing portions 243a, 243b, and 243c and the G3G4 mask pressing portions 334a, 334b, and 334c. The G4 lens 240 and the G3G4 mask 330 are biased and held at different locations at the same time.

In the outer area 134 of the barrel gasket 130, the lens holder contact surface 135 is disposed in a ring shape on the gasket contact surface 111, and the outer biasing protrusion 137 is also disposed in a ring shape.

### SECOND EMBODIMENT

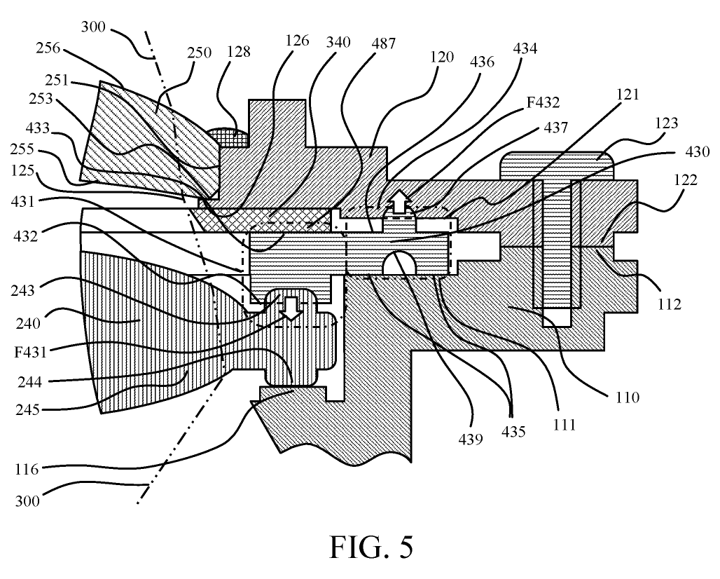

FIG. 5 explains a lens barrel 100 according to this embodiment. This embodiment is a variation of the first embodiment, and will discuss only the structure different from that of the first embodiment. This embodiment will omit a detailed description of the same structure as that of the first embodiment by designating it by the same reference numeral. Regarding a barrel gasket 430 in FIG. 5, those elements designated by reference numerals having four-hundredths replaced with reference numerals having one-hundredths in the barrel gasket 130 of the first embodiment have substantially the same functions. For example, the inner area 131 in the first embodiment corresponds to an inner area 431 in this embodiment.

In this embodiment, the biasing protrusion 437 outside the barrel gasket 430 is a protrusion with a semicircular section that protrudes from the fin-like shape toward the lens cover 120. If the biasing protrusion 137 has such a shape, it can bias the lens cover 120 with a force stronger than that of the biasing protrusion 137. However, in this case, depending on a protruding amount of the biasing protrusion 437, a compression amount of the barrel gasket 430 may be excessive, and the reaction force may be too strong. Therefore, this embodiment provides a concave portion 439 for protrusion escape in order to reduce the reaction force caused by the compression. At this time, the lens holder contact surface 435 is approximately the same plane divided by the concave portion 439.

In the inner area 431, the G4G5 mask 340 is attached as a separate part to the lens cover 120. In the first embodiment, the inner gasket contact surface 127 contacts the lens cover contact surface 133. In this embodiment, the inner gasket contact surface 487 of the G4G5 mask 340, which is configured as a flat surface, contacts the mask contact surface 433 of the barrel gasket 430, which is configured as the same flat surface.

In the barrel gasket 430, a step is provided between the lens biasing surface 432 and the lens holder contact surface 435 so that they are not coplanar and are configured to be less susceptible to mutual displacement.

In this embodiment, the G4 lens 240 directly contacts the optical component contact surface 116 of the lens holder 110. The first embodiment cannot eliminate the influence of component tolerances and deformations of the G3G4 mask 330 on the optical performance of the G4 lens 240, but in the above structure, there is no influence of the G3G4 mask 330, the optical performance can be easily adjusted.

While the disclosure has described example embodiments, it is to be understood that the disclosure is not limited to the example embodiments. The scope of the following claims is to be accorded the broadest interpretation so as to encompass all such modifications and equivalent structures and functions.

Each embodiment can provide a lens barrel that can seal the optical system for anti-fogging and bias a lens while suppressing deterioration of optical performance.

This application claims priority to Japanese Patent Application No. 2024-091966, which was filed on June 6, 2024, and which is hereby incorporated by reference herein in its entirety.

What is claimed is:

1. A lens barrel comprising:
a first fixed member and a second fixed member fixed to each other;
a lens disposed inside the first fixed member; and
an elastic member disposed between the first fixed member and the second fixed member in an optical axis direction,
wherein the elastic member has a first area that is disposed between the second fixed member and the lens and biases the lens, and a second area whose entire circumference is sandwiched between the first fixed member and the second fixed member, and
wherein a surface of the first area that biases the lens is different from a surface of the second area that biases the first fixed member.

2. The lens barrel according to claim 1, wherein a first biasing force of the first area that biases the lens is different from a second biasing force of the second area that biases the first fixed member.

3. The lens barrel according to claim 2, wherein the first biasing force is smaller than the second biasing force.

4. The lens barrel according to claim 1, wherein the elastic member is disposed between the lens and another adjacent lens in the optical axis direction.

5. The lens barrel according to claim 1, wherein the surface of the second area that contacts the first fixed member is flat.

6. The lens barrel according to claim 1, wherein the lens is sandwiched between the elastic member and an inelastic member, and
wherein a surface of the lens that is biased against the elastic member and a surface of the lens that contacts the inelastic member overlap each other when viewed from the optical axis direction.

7. The lens barrel according to claim 1, wherein the elastic member biases the lens at a plurality of positions.

8. The lens barrel according to claim 1, wherein the elastic member has an anti-rotation mechanism.

9. The lens barrel according to claim 1, wherein the elastic member is made of butyl rubber or fluororubber.

10. The lens barrel according to claim 1, wherein the second area has a protrusion that contacts the second fixed member.

11. The lens barrel according to claim 1, wherein the surface of the second fixed member that contacts the first area is flat.

12. The lens barrel according to claim 1, wherein the lens is a plastic lens.

13. An observation apparatus comprises:
a lens barrel; and
a diopter adjusting unit configured to adjust a diopter,
wherein the lens barrel includes:
a first fixed member and a second fixed member fixed to each other;
a lens disposed inside the first fixed member; and
an elastic member disposed between the first fixed member and the second fixed member in an optical axis direction,
wherein the elastic member has a first area that is disposed between the second fixed member and the lens and biases the lens, and a second area whose entire circumference is sandwiched between the first fixed member and the second fixed member, and
wherein a surface of the first area that biases the lens is different from a surface of the second area that biases the first fixed member.

14. An image pickup apparatus comprising:
a lens barrel; and
an image sensor,
where the lens barrel includes:
a first fixed member and a second fixed member fixed to each other;
a lens disposed inside the first fixed member; and
an elastic member disposed between the first fixed member and the second fixed member in an optical axis direction,
wherein the elastic member has a first area that is disposed between the second fixed member and the lens and biases the lens, and a second area whose entire circumference is sandwiched between the first fixed member and the second fixed member, and
wherein a surface of the first area that biases the lens is different from a surface of the second area that biases the first fixed member.
